(19) United States
(12) Patent Application Publication
(10) Pub. No.: US 2016/0303992 A1
(43) Pub. Date: Oct. 20, 2016

(54) Electrified Vehicle Predictive Low-Voltage Battery Alert

(71) Applicant: Ford Global Technologies, LLC, Dearborn, MI (US)

(72) Inventors: Karin Lovett, Novi, MI (US); Ryan J. Skaff, Farmington Hills, MI (US)

(21) Appl. No.: 14/686,034

(22) Filed: Apr. 14, 2015

(51) Int. Cl. B60L 11/18; B60W 50/14; B60W 10/26; B60W 10/06; B60W 10/08; B60L 3/12; B60W 20/13

(52) U.S. Cl. CPC B60L 11/1868; B60L 3/12; B60W 50/14; B60W 20/13; B60W 10/06; B60W 10/08; B60W 10/26; B60W 2050/143; B60W 2510/244; B60W 2710/06; B60W 2710/086; B60W 2710/244; Y10S 903/93

(57) ABSTRACT

A vehicle includes a traction battery and an auxiliary battery. A battery management system may be configured to transfer energy from the traction battery to the auxiliary battery during an ignition-off period. A controller is programmed to, in response to detecting conditions during the ignition-off period inhibiting an energy transfer from the traction battery to the auxiliary battery while a voltage of the auxiliary battery is less than a threshold and the traction battery is decoupled from the auxiliary battery, output a low-voltage alert. Conditions inhibiting the energy transfer include a state of charge of the traction battery being less than a predetermined state of charge and a traction battery voltage being less than a predetermined value. The low-voltage alert may be output via a wireless communications network to a device remote from the vehicle to alert the operator of the condition.

### TECHNICAL FIELD

This application is generally related to a low voltage warning of an auxiliary battery for hybrid-electric and electric vehicles.

### BACKGROUND

Hybrid-electric and electric vehicles utilize a traction battery to provide power for propulsion and accessory loads. Vehicles that utilize a high-voltage traction battery may be referred to as electrified vehicles. These vehicles also include an auxiliary battery that outputs a lower voltage level than the traction battery. The auxiliary battery provides power to various low voltage loads and electronics modules. The traction battery may supply power to electric machines for propulsion. In the hybrid-electric vehicle, the electric machines may be used for starting an engine to provide propulsion. Electronic modules that receive power from the auxiliary battery typically require a certain voltage level to remain operable. If the auxiliary battery voltage falls below a certain voltage, operation of the electronic modules may not be guaranteed.

### SUMMARY

A vehicle includes an auxiliary battery and a traction battery. The vehicle further includes a controller programmed to, in response to detecting conditions, during an ignition-off period, inhibiting an energy transfer from the traction battery to the auxiliary battery while a voltage of the auxiliary battery is less than a threshold and the traction battery is decoupled from the auxiliary battery, output a low-voltage alert.

A battery management system includes at least one controller programmed to, in response to detecting conditions during an ignition-off period inhibiting an energy transfer from a fraction battery to an auxiliary battery while a voltage of the auxiliary battery is less than a threshold and the traction battery is decoupled from the auxiliary battery, output a low-voltage alert.

The vehicle may further include a wireless communications module. The at least one controller may be further programmed to output the low-voltage alert via the wireless communications module to a device remote from the vehicle.

In some configurations, the vehicle may further include an engine and an electric machine mechanically coupled to the engine and electrically coupled to the traction battery. The at least one controller may be further programmed to receive an ignition-on request from the device via the wireless communications module, and in response to the ignition-on request, start the engine and operate the electric machine to generate electricity to recharge the traction battery and the auxiliary battery. The at least one controller may be further programmed to, in response to the low-voltage alert, command the engine to start and operate the electric machine to generate electricity to recharge the traction battery and the auxiliary battery.

A method for generating a low-voltage alert in a vehicle includes outputting, by a controller, the low-voltage alert in response to a voltage of an auxiliary battery being less than a predetermined voltage in a presence of conditions inhibiting an energy transfer from a traction battery to the auxiliary battery during an ignition-off period. The method may further include communicating, by the controller, the low-voltage alert to a device remote from the vehicle. The method may further include, in response to outputting the low-voltage alert, starting an engine of the vehicle and operating an electric machine coupled to the engine to recharge the traction battery and the auxiliary battery.

The threshold may be voltage such that an amount of energy is stored in the auxiliary battery to supply an ignition-off load for a predetermined time. The threshold may be a voltage greater than a minimum low-voltage level of the auxiliary battery.

The conditions inhibiting the energy transfer may include a state of charge of the fraction battery being less than a predetermined state of charge. The conditions inhibiting the energy transfer may include a traction battery voltage being less than a predetermined value. The conditions inhibiting the energy transfer may include a diagnostic condition that disables operation of the fraction battery.

### BRIEF DESCRIPTION OF THE DRAWINGS

FIG. 1 is a diagram of a hybrid vehicle illustrating typical drivetrain and energy storage components.

FIG. 2 is a diagram of a possible system for monitoring an auxiliary battery.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

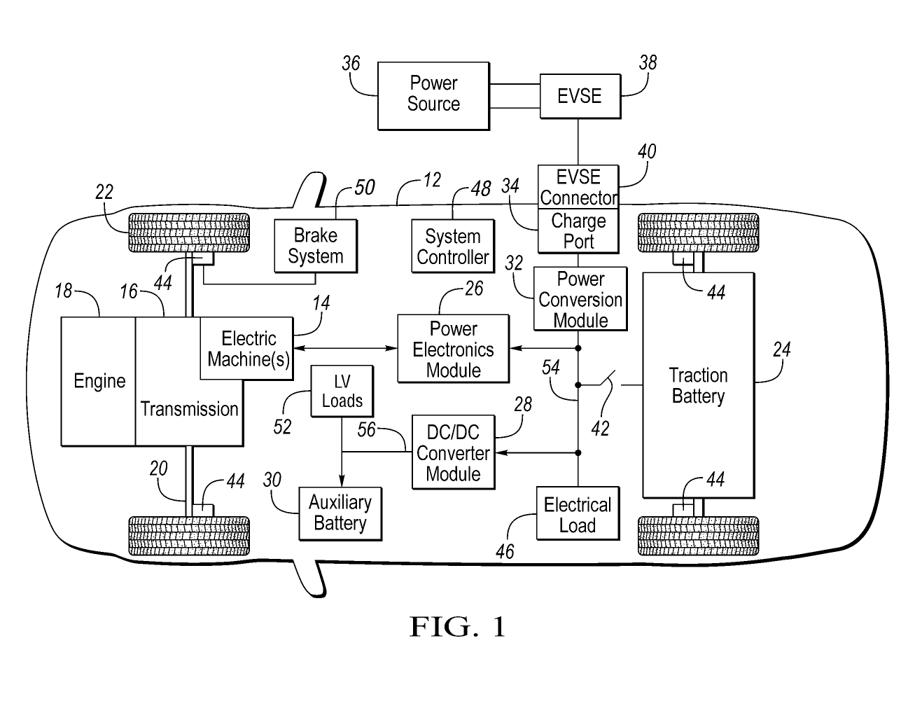

FIG. 1 depicts a typical plug-in hybrid-electric vehicle (PHEV). A PHEV 12 may comprise one or more electric machines 14 mechanically coupled to a hybrid transmission 16. The electric machines 14 may be capable of operating as a motor or a generator. In addition, the hybrid transmission 16 is mechanically coupled to an engine 18. The hybrid transmission 16 is also mechanically coupled to a drive shaft 20 that is mechanically coupled to the wheels 22. The electric machines 14 can provide propulsion and deceleration capability when the engine 18 is turned on or off. The electric machines 14 also act as generators and can provide fuel economy benefits by recovering energy that would normally be lost as heat in a friction braking system. The electric machines 14 may also reduce vehicle emissions by allowing the engine 18 to operate at more efficient speeds and allowing the hybrid-electric vehicle 12 to be operated in electric mode with the engine 18 off under certain conditions.

A traction battery or battery pack 24 stores energy that can be used by the electric machines 14. A vehicle battery pack 24 typically provides a high-voltage direct current (DC) output. One or more contactors 42 may isolate the traction battery 24 from a high-voltage bus 54 when opened and couple the traction battery 24 to the high-voltage bus 54 when closed. The traction battery 24 is electrically coupled to one or more power electronics modules 26 via the high-voltage bus 54. The power electronics module 26 is also electrically coupled to the electric machines 14 and provides the ability to bi-directionally transfer energy between high-voltage bus 54 and the electric machines 14. For example, a traction battery 24 may provide a DC voltage while the electric machines 14 may operate with a three-phase alternating current (AC) to function. The power electronics module 26 may convert the DC voltage to a three-phase AC current to operate the electric machines 14. In a regenerative mode, the power electronics module 26 may convert the three-phase AC current from the electric machines 14 acting as generators to the DC voltage compatible with the traction battery 24. The description herein is equally applicable to a pure electric vehicle. For a pure electric vehicle, the hybrid transmission 16 may be a gear box connected to an electric machine 14 and the engine 18 may not be present.

In addition to providing energy for propulsion, the traction battery 24 may provide energy for other vehicle electrical systems. A vehicle 12 may include a DC/DC converter module 28 that is electrically coupled to the high-voltage bus 54. The DC/DC converter module 28 may be electrically coupled to a low-voltage bus 56. The DC/DC converter module 28 may convert the high voltage DC output of the traction battery 24 to a low voltage DC supply that is compatible with low-voltage vehicle loads 52. The low-voltage bus 56 may be electrically coupled to an auxiliary battery 30 (e.g., 12V battery). The low-voltage systems 52 may be electrically coupled to the low-voltage bus 56. The low-voltage system 52 may include various controllers within the vehicle 12. If the voltage of the auxiliary battery 30 falls below a minimum threshold voltage, the low-voltage systems 52 may not be able to power up and operate. The result of the low-voltage systems 52 being inoperative may be a loss of ability to start and operate the vehicle. For example, if a controller that manages the traction battery 24 cannot be powered up, the contactors 42 may remain open.

The vehicle 12 may be an electric vehicle or a plug-in hybrid vehicle in which the fraction battery 24 may be recharged by an external power source 36. The external power source 36 may be a connection to an electrical outlet. The external power source 36 may be electrically coupled to a charger or electric vehicle supply equipment (EVSE) 38. The external power source 36 may be an electrical power distribution network or grid as provided by an electric utility company. The EVSE 38 may provide circuitry and controls to regulate and manage the transfer of energy between the power source 36 and the vehicle 12. The external power source 36 may provide DC or AC electric power to the EVSE 38. The EVSE 38 may have a charge connector 40 for plugging into a charge port 34 of the vehicle 12. The charge port 34 may be any type of port configured to transfer power from the EVSE 38 to the vehicle 12. The charge port 34 may be electrically coupled to a charger or on-board power conversion module 32. The power conversion module 32 may condition the power supplied from the EVSE 38 to provide the proper voltage and current levels to the traction battery 24. The power conversion module 32 may interface with the EVSE 38 to coordinate the delivery of power to the vehicle 12. The EVSE connector 40 may have pins that mate with corresponding recesses of the charge port 34. Alternatively, various components described as being electrically coupled or connected may transfer power using a wireless inductive coupling.

One or more wheel brakes 44 may be provided for decelerating the vehicle 12 and preventing motion of the vehicle 12. The wheel brakes 44 may be hydraulically actuated, electrically actuated, or some combination thereof. The wheel brakes 44 may be a part of a brake system 50. The brake system 50 may include other components to operate the wheel brakes 44. For simplicity, the figure depicts a single connection between the brake system 50 and one of the wheel brakes 44. A connection between the brake system 50 and the other wheel brakes 44 is implied. The brake system 50 may include a controller to monitor and coordinate the brake system 50. The brake system 50 may monitor the brake components and control the wheel brakes 44 for vehicle deceleration. The brake system 50 may respond to driver commands via a brake pedal and may also operate autonomously to implement features such as stability control. The controller of the brake system 50 may implement a method of applying a requested brake force when requested by another controller or sub-function.

One or more electrical loads 46 may be coupled to the high-voltage bus 54. The electrical loads 46 may have an associated controller that operates and controls the electrical loads 46 when appropriate. The high-voltage loads 46 may include compressors and electric heaters.

The various components discussed may have one or more associated controllers to control and monitor the operation of the components. The controllers may communicate via a serial bus (e.g., Controller Area Network (CAN)) or via discrete conductors. In addition, a system controller 48 may be present to coordinate the operation of the various components.

During an ignition-off condition, the contactors 42 may be in an open state so that the traction battery 24 does not provide power to the high-voltage bus 54. During the ignition-off condition, the traction battery 24 may be decoupled from the auxiliary battery 30. During the ignition-off condition selected electronic modules (e.g., low-voltage loads 52) may be active. For example, a theft-deterrent system and a remote keyless entry system may continue to be active. The active systems may draw current from the auxiliary battery 30. In some configurations, low-voltage loads 52, such as lamps, may be accidently left in an active condition and draw current from the auxiliary battery 30 which may increase a rate of discharge of the auxiliary battery 30. During the ignition-off condition, the low-voltage loads 52 may be configured to minimize current draw.

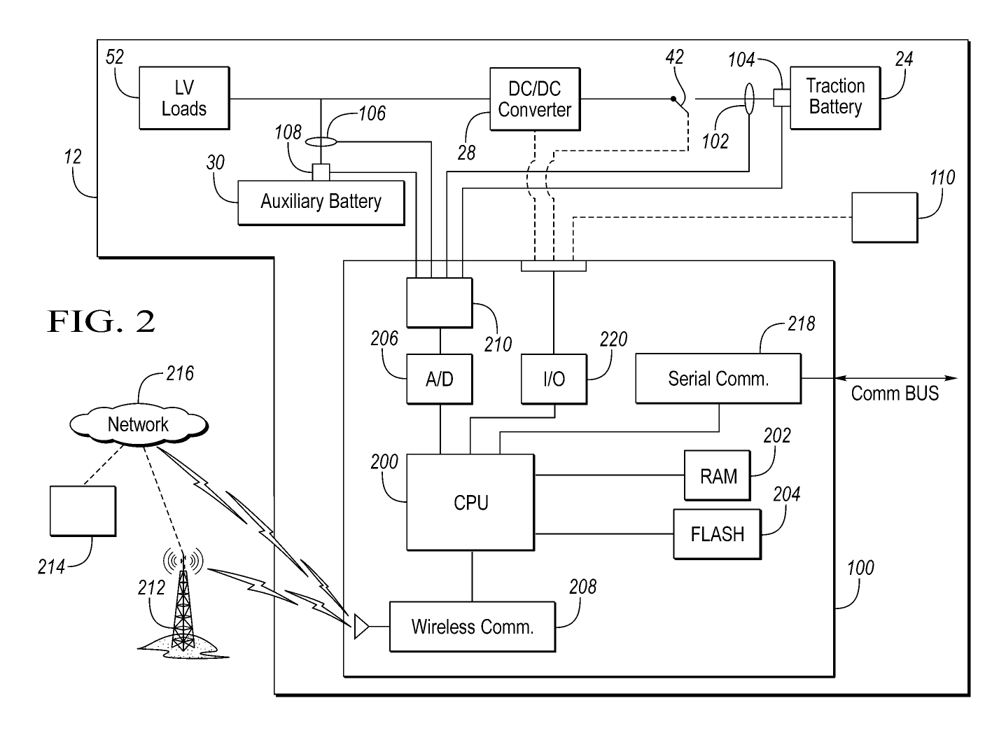

FIG. 2 depicts one possible diagram of a controller 100 that interfaces with the auxiliary battery 30 and the traction battery 24 to implement a battery management system. The controller 100, although represented as a single controller, may be implemented as one or more controllers. The controller 100 may monitor operating conditions of the traction battery 24 and the auxiliary battery 30. A traction battery current sensor 102 may be coupled to the traction battery 24 to sense a current that flows through the traction battery 24. A traction battery voltage sensor 104 maybe coupled to the traction battery 24 to sense a voltage across terminals of the traction battery 24. The traction battery voltage sensor 104 may output a signal indicative of the voltage across the terminals of the traction battery 24. The traction battery current sensor 102 may output a signal of a magnitude and direction of current flowing through the traction battery 24.

An auxiliary battery current sensor 106 may be coupled to the auxiliary battery 20 to sense a current that flows through the auxiliary battery 30. An auxiliary battery voltage sensor 108 maybe coupled to the auxiliary battery 30 to sense a voltage across terminals of the auxiliary battery 30. The auxiliary battery voltage sensor 108 may output a signal indicative of the voltage across the terminals of the auxiliary battery 30. The auxiliary battery current sensor 106 may output a signal of a magnitude and direction of current flowing through the auxiliary battery 30.

The outputs of traction battery current sensor 102 and the traction battery voltage sensor 104 may be input to the controller 100. The outputs of the auxiliary battery current sensor 106 and the auxiliary battery voltage sensor 108 may be input to the controller 100. The controller 100 may include interface circuitry 210 to filter and scale the current sensor signals and the voltage sensor signals.

The controller 100 may be configured to compute a state of charge of the traction battery 24 based on the signals from the traction battery current sensor 102 and the traction battery voltage sensor 104. Various techniques may be utilized to compute the state of charge. For example, an ampere-hour integration may be implemented in which the current through the traction battery 24 is integrated over time. The state of charge may also be estimated based on the output of the traction battery voltage sensor 104. The specific technique utilized may depend upon the chemical composition and characteristics of the particular battery. Similarly, the controller 100 may compute a state of charge of the auxiliary battery 24 based on the signals from the auxiliary battery current sensor 106 and the auxiliary battery voltage sensor 108. In some configurations, the state of charge of the auxiliary battery 30 may be estimated from the output of the auxiliary battery voltage sensor 108.

A state of charge operating range may be defined for the auxiliary battery 30 and the fraction battery 24. The operating ranges may define an upper and lower limit at which the state of charge may be bounded for each battery 24, 30. During vehicle operation, the controller 100 may be configured to maintain the state of charge of the batteries 24, 30 within the associated operating range. During the ignition-off condition, the state of charge of the auxiliary battery 30 may decrease due to low-voltage loads 52 that operate during the ignition-off condition as well as any parasitic loads that may be present in the low-voltage loads 52. Similarly, the state of charge of the traction battery 24 may decrease due to electrical loads 46 coupled to the traction battery 24 or internal fraction battery chemical reactions. In addition, if the contactors 42 are closed, the DC/DC Converter Module 28 may be activated and draw power from the traction battery 24 to supply the low-voltage bus 56.

As the state of charge of the auxiliary battery 30 decreases, the voltage of the auxiliary battery 30 may decrease. An auxiliary battery low-voltage limit may be defined. The auxiliary battery low-voltage limit may be configured to be a voltage level at which the auxiliary battery 30 should be charged to ensure that sufficient energy is stored in the auxiliary battery 30 to support the low-voltage loads 52 during ignition-off conditions for a predetermined period of time. Additionally, an auxiliary battery minimum voltage limit may be defined as that voltage level below which the low-voltage loads 52 may not be able to operate. The auxiliary battery voltage limits may also be defined as auxiliary battery state of charge limits. Similarly, traction battery low-voltage limits or state of charge limits may be defined.

In an electrified vehicle, stored energy from the traction battery 24 may be used to charge the auxiliary battery 30. During vehicle operation (e.g., an ignition-on condition) energy from the traction battery 24 and the electric machines 14 is used to provide power to the auxiliary battery 30 and low-voltage loads 52 via the DC/DC converter module 28. However, in an ignition-off condition, the contactors 42 may be opened so that the traction battery 24 is isolated from the DC/DC converter module 28. In this situation, no energy is transferred from the traction battery 24 to the auxiliary battery 30 as the batteries are decoupled.

The controller 100 may be configured to monitor the status of the auxiliary battery 30 and request an energy transfer from the traction battery 24 to charge the auxiliary battery 30 under various conditions. In some configurations, the controller 100 may compare the voltage of the auxiliary battery 30 to the auxiliary battery low-voltage limit. In response to the auxiliary battery voltage being less than the auxiliary battery low-voltage limit, the controller 100 may request the energy transfer from the traction battery 24. In some configurations, the controller 100 may compare the auxiliary battery state of charge to an auxiliary battery low state of charge limit. In response to the auxiliary battery state of charge being less than the auxiliary battery low state of charge limit, the controller 100 may request the energy transfer from the traction battery 24. The controller 100 may monitor the status during ignition-off conditions. To reduce power consumption by the controller 100 during ignition-off conditions, the controller 100 may be configured to periodically wake up to check the status of the auxiliary battery 30.

The controller 100 may be configured to output a low-voltage alert when the auxiliary battery voltage is below a predetermined voltage level. The low-voltage alert conditions may be monitored during the ignition-off period. In some configurations, the predetermined voltage level may be the auxiliary battery low-voltage limit. In such a configuration, the low-voltage alert may be unnecessary because the same condition may trigger a transfer of energy from the traction battery 24 to the auxiliary battery 30. An operator receiving the low-voltage alert may arrive at the vehicle 12 to discover that the low-voltage condition is no longer present. A more effective low-voltage alert may be conditioned upon the transfer of energy from the traction battery 24 being inhibited.

Conditions in which a transfer of energy from the traction battery 24 to the auxiliary battery 30 is inhibited may include the traction battery voltage being less than a predetermined voltage. The conditions may also include the traction battery state of charge being less than a predetermined state of charge. The predetermined voltage and predetermined state of charge may be a level at which the traction battery 24 is not operated due to performance or battery life considerations. Other conditions may include diagnostic conditions that inhibit operation of the traction battery 24. In some configurations, diagnostic conditions pertaining to the DC/DC converter module 28 may inhibit the transfer of energy. The low-voltage alert may be conditioned upon the inability to transfer energy from the traction battery 24. By conditioning the low-voltage alert on the ability to transfer energy from the traction battery 24, the operator is given a conclusive warning regarding the state of the auxiliary battery 30. The operator may no longer be warned of low-voltage conditions that occur when a transfer of energy from the traction battery 24 is possible. This may prevent unnecessary warnings to the operator.

In response to a request for the energy transfer from the traction battery 24, the contactors 42 may be closed to couple the traction battery 24 to the DC/DC converter 28 and ultimately the auxiliary battery 30. In some configurations, closing the contactors 42 may activate operation of the DC/DC converter 28. In some configurations, the controller 100 may manage and control operation of the DC/DC converter 28 after the contactors 42 are closed via one or more control signals.

The controller 100 may include a processor 200 that controls at least some portion of the operation of the controller 100. The processor 200 allows onboard processing of commands and routines. The processor 200 may be coupled to non-persistent storage 202 and persistent storage 204. In this illustrative configuration, the non-persistent storage 202 is random access memory (RAM) and the persistent storage 204 is flash memory. In general, persistent (non-transitory) storage 204 can include all forms of storage that maintain data when a computer or other device is powered down. The controller 100 may include a serial communications module 218 that interfaces the processor 200 to the communication bus. The communications bus may be CAN, Ethernet, or other appropriate network within the vehicle.

The processor 200 may be coupled to an Analog-to-Digital converter 206 that is configured to convert analog signals to digital form. For example, the outputs from the interface circuitry 210 for the current and voltage sensor signals may be coupled to the A/D converter 206 for input to the processor 200. The processor 200 may be coupled to an input/output (I/O) module 220 that is configured to interface with the various devices and components. The I/O module 220 may include circuitry to ensure that signals are input and output at a specified voltage and current level.

The vehicle 12 may include an indicator 110 (e.g., lamp, display module) that is configured to indicate the low-voltage alert to the operator. The indicator 110 may interface with the processor 200 via the I/O module 220. The indicator 110 may be within the vehicle 12. When the operator is not in the vicinity of the vehicle 12, a different means of providing the alert may be desired. The controller 100 may be programmed to output the low-voltage alert in response to the auxiliary battery voltage being less than a threshold when conditions inhibiting the energy transfer from the traction battery 24 to the auxiliary battery 30 are detected during the ignition-off period.

The controller 100 may include a wireless communications module 208 to communicate with devices 214 remote from the vehicle 12. The wireless communications module 208 may include an onboard modem having an antenna to communicate with off-board devices 214. The wireless communications module 208 may be a cellular communications device to enable communications via a cellular data network 212. The wireless communications module 208 may be a wireless local area network (LAN) device compatible with IEEE 802.11 family of standards (i.e., WiFi) or a WiMax network. The wireless communications module 208 may include a vehicle based wireless router to allow connection to remote networks 216 in range of a local router. The wireless communications module 208 may be configured to establish communication with a nomadic device 214 (e.g., phone, tablet, computer). The nomadic device 214 may be connected to an external network 216. The controller 100 may be programmed to implement an appropriate communications protocol in hardware and software that is compatible with a selected mode of wireless communication. Although depicted as part of the controller 100, the wireless communications module 208 may be part of a different controller within the vehicle 12 and the controller 100 may interface with the different controller via the serial communications bus.

The low-voltage alert may be communicated via the wireless communications module 208 to the nomadic device 214. The nomadic device 214 may include a processor and associated volatile and non-volatile memory that is configured to store and execute programs or applications. For example, the nomadic device 214 may execute an application such as MyFord Mobile that is configured to transfer vehicle related status and commands between the nomadic device 214 and the vehicle 12. In some configurations, the nomadic device 214 may include a web browser application. Communication with the vehicle 12 may be established via a web-based interface. The nomadic device 214 may receive a communication that includes the low-voltage alert. The nomadic device 214 may display the low-voltage alert to the operator on a display screen associated with the nomadic device 214. Upon receiving the low-voltage alert, the operator may decide upon a course of action.

The nomadic device 214 may include various ways of indicating the low-voltage alert. The application may run as a background task and periodically monitor for a received message. When a message is received that includes the low-voltage alert, a notification may be generated. The notification may interrupt a currently running application. Further, if the nomadic device 214 is in a sleep state, the application may wake up the nomadic device 214 to indicate the low-voltage alert. The application may indicate the low-voltage alert with a visual indication (e.g., on-screen message, flashing light), an audible indication (e.g., sound through a speaker), and/or a tactile indication (e.g., vibration of the nomadic device 214).

In response to the low-voltage alert, the operator may visit the vehicle 12 and start the engine 18 for a period of time to allow the traction battery 24 and auxiliary battery 30 to recharge. The battery management system may be configured to ensure that the low-voltage alert is issued when there is sufficient energy remaining in the traction battery 24 and the auxiliary battery 30 to start the vehicle 12. The state of charge of the traction battery 24 may be such that an amount of energy is stored in the traction battery 24 that is sufficient to start the engine 18. The voltage and state of charge of the auxiliary battery 30 may be such that an amount of energy stored in the auxiliary battery 30 is sufficient to supply an ignition-off load for a predetermined time. The low-voltage alert may be issued at a time in which the operator may still take corrective actions before vehicle operation is inhibited.

In some configurations, the application executed by the nomadic device 214 may provide an option for the operator to start the engine 18 remotely. In response to receiving the low-voltage alert, the operator may command an ignition-on via the application executed by the nomadic device 214. The controller 100 may be configured to receive the ignition-on command and issue instructions within the vehicle 12 to start the engine 18. The controller 100 may command operation of the power electronics module 26 and electric machines 14 to generate electricity. The controller 100 may maintain the engine 18 in a running condition until the traction battery 24 has achieved a predetermined state of charge and/or voltage and the auxiliary battery 30 has achieved a predetermined state of charge and/or voltage. When the batteries 24, 30 are sufficiently charged, the controller 100 may issue instructions to stop the engine 18 and return to the ignition-off condition. Additional conditions may be implemented to enable starting the engine 18. For example, the controller 100 may determine that the vehicle 12 is in a ventilated area and that sufficient fuel is available before starting the engine 18.

In some configurations, the controller 100 may be configured to automatically start the engine in response to the low-voltage alert. This option may be configurable by the operator. The low-voltage alert may still be output along with an engine status indication. In an electric-vehicle configuration, the operator may be able to remotely command charging of the vehicle 12 provided that the charger 38 is connected to the vehicle 12 and operational. In other electric-vehicle configurations, charging of the traction battery 24 may occur automatically when the charger 38 is connected and operational.

The low-voltage alert strategy may be applicable to any vehicle that includes a traction battery 24 and an auxiliary battery 30. For example, electric vehicles may include the auxiliary battery 30 to retain compatibility with low-voltage components. The electric vehicle or plug-in hybrid-electric vehicle may be placed on a charger 38 during periods of non-use. The low-voltage strategy is still applicable as there may be situations in which the charger 38 and/or the external power source 36 are non-functional. The low-voltage alert serves to remind the operator to plug in the charge connector 40 or otherwise confirm operation of the charging equipment 38. In the event that the charger 38 is connected and operational, the low-voltage alert may not be issued as the traction battery may be charged to a level above the warning threshold.

The low-voltage alert may be removed when the auxiliary battery 30 has been recharged above a predetermined voltage level or predetermined state of charge level. The level may be greater than the voltage or state of charge threshold below which the low-voltage alert is generated. The low-voltage alert may be removed when conditions that inhibit the transfer of energy from the traction battery 24 are no longer present.

The functions described may be implemented in a single controller 100 or the functions may be implemented in multiple controllers. In a system having multiple controllers, data may be communicated between controllers via the serial communications bus. Components shown and described may be coupled to one or more of the multiple controllers.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an auxiliary battery;
a traction battery; and
a controller programmed to, in response to detecting conditions during an ignition-off period inhibiting an energy transfer from the traction battery to the auxiliary battery while a voltage of the auxiliary battery is less than a threshold and the traction battery is decoupled from the auxiliary battery, output a low-voltage alert.

2. The vehicle of claim 1 wherein the conditions inhibiting the energy transfer include a state of charge of the traction battery being less than a predetermined state of charge.

3. The vehicle of claim 1 wherein the conditions inhibiting the energy transfer include a traction battery voltage being less than a predetermined value.

4. The vehicle of claim 1 wherein the conditions inhibiting the energy transfer include a diagnostic condition that disables operation of the traction battery.

5. The vehicle of claim 1 wherein the threshold is a voltage such that an amount of energy is stored in the auxiliary battery to supply an ignition-off load for a predetermined time.

6. The vehicle of claim 1 wherein the threshold is a voltage greater than a minimum low voltage level of the auxiliary battery.

7. The vehicle of claim 1 further comprising a wireless communications module coupled to the controller, and wherein the controller is further programmed to transfer the low-voltage alert via the wireless communications module to a device remote from the vehicle.

8. The vehicle of claim 7 further comprising an engine and an electric machine mechanically coupled to the engine and electrically coupled to the traction battery, and wherein the controller is further programmed to receive an ignition-on request from the device via the wireless communications module, and, in response to the ignition-on request, start the engine and operate the electric machine to generate electricity to recharge the traction battery and the auxiliary battery.

9. The vehicle of claim 1 further comprising an engine and an electric machine mechanically coupled to the engine and electrically coupled to the traction battery, and wherein the controller is further programmed to, in response to the low-voltage alert, command the engine to start and operate the electric machine to generate electricity to recharge the traction battery and the auxiliary battery.

10. A battery management system comprising:
at least one controller programmed to, in response to detecting conditions during an ignition-off period inhibiting an energy transfer from a traction battery to an auxiliary battery while a voltage of the auxiliary battery is less than a threshold and the traction battery is decoupled from the auxiliary battery, output a low-voltage alert.

11. The battery management system of claim 10 wherein the conditions inhibiting the energy transfer include one or more of a state of charge of the traction battery being less than a predetermined state of charge, a traction battery voltage being less than a predetermined value, and a diagnostic condition that disables operation of the traction battery.

12. The battery management system of claim 10 wherein the at least one controller is further programmed to output the low-voltage alert via a wireless communications module to a remote device.

13. The battery management system of claim 12 wherein the at least one controller is further programmed to receive an ignition-on request from the remote device via the wireless communications module, and in response to the ignition-on request, command an engine to start and command an electric machine to generate electricity to recharge the traction battery and the auxiliary battery.

14. The battery management system of claim 10 wherein the threshold is a voltage such that an amount of energy is stored in the auxiliary battery to supply an ignition-off load for a predetermined time.

15. The battery management system of claim 10 wherein the at least one controller is further programmed to, in response to the low-voltage alert, command an engine to start and command an electric machine to generate electricity to recharge the traction battery and the auxiliary battery.

16. A method for generating a low-voltage alert in a vehicle, the method comprising:
outputting, by a controller, the low-voltage alert, in response to detecting conditions during an ignition-off period that inhibit an energy transfer from a traction battery to an auxiliary battery while a voltage of the auxiliary battery is less than a threshold and the traction battery is decoupled from the auxiliary battery.

17. The method of claim 16 further comprising communicating, by the controller, the low-voltage alert to a device remote from the vehicle.

18. The method of claim 16 further comprising, in response to outputting the low-voltage alert, starting an engine of the vehicle and operating an electric machine coupled to the engine to recharge the traction battery and the auxiliary battery.

19. The method of claim 16 wherein the conditions inhibiting the energy transfer include a state of charge of the traction battery being less than a predetermined state of charge.

20. The method of claim 16 wherein the conditions inhibiting the energy transfer include a traction battery voltage being less than a predetermined value.
